(19) United States
(12) Patent Application Publication
(10) Pub. No.: US 2003/0081728 A1
(43) Pub. Date: May 1, 2003

(54) X-ray generator

(76) Inventors: Biju S. Nathan, Bangalore (IN); Ravindra P. Prabhu, Bangalore (IN); Balasubramannian Kandankumarath, Bangalore (IN)

Correspondence Address: Patrick W. Rasche, Armstrong Teasdale LLP, Suite 2600, One Metropolitan Sq., St. Louis, MO, 63102, US

(21) Appl. No.: 10/283,404

(22) Filed: Oct. 29, 2002

(30) Foreign Application Priority Data
Oct. 31, 2001 (JP) 2001-334151

(51) Int. Cl. H05H 1/00

(52) U.S. Cl. 378/119

(57) ABSTRACT

An object of the present invention is to provide a circuit for generating a pair of well-balanced positive and negative dc high voltages, and an X-ray generator including such a high-voltage generation circuit. The X-ray generator includes a transformer, a pair of rectifier-type dc high-voltage generation circuits, and an X-ray tube. The transformer transfers an ac voltage, which is applied to a primary winding thereof and stepped up, from a single secondary winding thereof that has one terminal thereof grounded. The pair of rectifier-type dc high-voltage generation circuits generates positive and negative dc high voltages according to an ac voltage developed at the other terminal of the secondary winding. The positive dc high voltage is applied to the anode of the X-ray tube, while the negative dc high voltage is applied to the cathode thereof.

### BACKGROUND OF THE INVENTION

The present invention relates to a high-voltage generation circuit and an X-ray generator, or more particularly, to a circuit for generating a dc high voltage for an X-ray tube and an X-ray generator including such a high-voltage generation circuit.

An X-ray generator having an X-ray tube includes a high-voltage generation circuit that applies a high voltage to the X-ray tube. The high-voltage generation circuit uses a transformer to step up an ac voltage so as to produce an ac high voltage. A dc high voltage resulting from rectification of the ac high voltage is applied to the X-ray tube. Another method adopts a rectifier-type dc high-voltage generation circuit as a rectification circuit so as to further step up the dc high voltage.

A dc high voltage is applied to an anode and a cathode of the X-ray tube. Specifically, a positive dc high voltage relative to a ground level is applied to the anode, while a negative dc high voltage relative to the ground level is applied to the cathode. The pair of positive and negative dc high voltages assumes the same absolute value. The pair of positive and negative dc high voltages results from rectification of a pair of ac high voltages developed at a pair of secondary windings of the step-up transformer.

As mentioned above, the method of generating a pair of positive and negative dc high voltages by rectifying the output voltages of a pair of secondary windings of a step-up transformer requires inclusion of two secondary windings, which share the same property, in a step-up transformer. This is because the absolute values of the pair of dc high voltages must be equal to each other. However, a transformer exhibiting a high step-up rate has difficulty in matching the properties of two secondary windings highly precisely. The imbalance between the pair of positive and negative dc high voltages cannot help being permitted to a certain degree.

Moreover, a step-up transformer having two secondary windings has a large volume. If the step-up transformer is adopted for an integrated type X-ray generator that has a high-voltage generation circuit and an X-ray tube stored in a common housing, it becomes hard to make the generator compact.

### SUMMARY OF THE INVENTION

Therefore, an object of the present invention is to realize a circuit for generating a pair of well-balanced positive and negative dc high voltages, and an X-ray generator having such a high-voltage generation circuit. Another object of the present invention is to realize an X-ray generator that is of an integrated type and can be easily designed compactly.

(1) In one aspect of the present invention that attempts to solve the aforesaid problems, there is provided a high-voltage generation circuit including: a transformer that transfers an ac voltage, which is applied to a primary winding thereof and stepped up, from a single secondary winding thereof that has one terminal thereof grounded; and a pair of rectifier-type dc high-voltage generation circuits that generates positive and negative dc high voltages according to an ac voltage developed at the other terminal of the secondary winding.

In the aspect of the present invention set forth in paragraph (1), the pair of rectifier-type dc high-voltage generation circuits generates positive and negative dc high voltages according to the ac voltage developed at the other terminal of the single secondary winding of the step-up transformer. The step-up transformer has one terminal thereof grounded. Consequently, a pair of well-balanced positive and negative dc high voltages can be generated. Moreover, since the single secondary winding is included, the transformer has a small volume.

(2) In another aspect of the present invention that attempts to solve the aforesaid problems, there is provided an X-ray generator including: a transformer that transfers an ac voltage, which is applied to a primary winding thereof and stepped up, from a single secondary winding thereof that has one terminal thereof grounded; a pair of rectifier-type dc high-voltage generation circuits that generates positive and negative dc high voltages according to an ac voltage developed at the other terminal of the secondary winding; and an X-ray tube that has the positive dc high voltage applied to an anode thereof and has the negative dc high voltage applied to a cathode thereof.

In the aspect of the present invention set forth in paragraph (2), the pair of rectifier-type dc high-voltage generation circuits generates positive and negative dc high voltages according to an ac voltage developed at the other terminal of the single secondary winding of the step-up transformer. The step-up transformer has one terminal thereof grounded. The positive and negative dc high voltages are applied to the anode and cathode of the X-ray tube respectively. Consequently, a pair of well-balanced positive and negative dc high voltages is applied to the anode and cathode of the X-ray tube. Moreover, since the single secondary winding is included, the transformer has a small volume. An X-ray generator of an integrated type can be designed compactly.

(3) In another aspect of the present invention that attempts to solve the aforesaid problems, there is provided an X-ray generator including: an inverter that changes a dc voltage into an ac voltage; a transformer that transfers the ac voltage, which is applied to a primary winding thereof by the inverter and stepped up, from a single secondary winding thereof that has one terminal thereof grounded; a pair of rectifier-type dc high-voltage generation circuits that generates positive and negative dc high voltages according to an ac voltage developed at the other terminal of the secondary winding; an X-ray tube that has the positive dc high voltage applied to an anode thereof and has the negative dc high voltage applied to a cathode thereof; a pair of voltage detection circuits that detects an anode voltage of the X-ray tube and a cathode voltage thereof; and a control circuit that controls the inverter according to detection signals produced by the pair of voltage detection circuits.

In the aspect of the present invention set forth in paragraph (3), the X-ray tube has the same features as the one set forth in paragraph (2). In addition, the inverter changes a dc voltage into an ac voltage and applies the ac voltage to the primary winding of the transformer. An anode voltage and a cathode voltage are detected. The inverter is controlled based on detection signals representing the detected anode voltage and cathode voltage. This results in a stabilized tube voltage.

(4) In another aspect of the present invention that attempts to solve the aforesaid problems, there is provided an X-ray generator including: an inverter that changes a dc voltage into an ac voltage; a transformer that transfers an ac voltage, which is applied to a primary winding thereof by the inverter and stepped up, from a single secondary winding thereof having one terminal thereof grounded; a pair of rectifier-type dc high-voltage generation circuits that generates positive and negative dc high voltages according to an ac voltage developed at the other terminal of the secondary winding; a current generation circuit that generates a current according to the ac voltage received from the inverter; an X-ray tube that has the positive dc high voltage applied to an anode thereof, has the negative dc high voltage applied to a cathode thereof, and has the current fed to a filament thereof; a pair of voltage detection circuits that detects an anode voltage of the X-ray tube and a cathode voltage thereof; a current detection circuit that detects a current flowing in the X-ray tube; a first control circuit that controls the inverter according to the detection signals produced by the pair of voltage detection circuits; and a second control circuit that controls the current generation circuit according to the detection signal produced by the current detection circuit.

In the aspect of the present invention set forth in paragraph (4), the X-ray generator has the same features as the one set forth in paragraph (3). In addition, a current flowing in the X-ray tube is detected. A filament current of the X-ray tube is controlled based on the detected current. This results in a stabilized tube current.

Preferably, the pair of rectifier-type dc high-voltage generation circuits each includes a Cockcroft's circuit so as to attain a high multiplication for a voltage.

Preferably, the pair of voltage detection circuits each includes voltage division resistors so as to realize simple circuitry.

Preferably, the current detection circuit includes a current detection resistor so as to realize simple circuitry.

Preferably, the current detection resistor has a capacitor connected in parallel therewith so as to smooth a detection signal.

Preferably, the current detection resistor includes series resistors, on both sides of which nodes to be used to connect an ammeter connection node are formed, so as to realize easy measurement of a tube current.

According to the present invention, there is provided a circuit for generating a pair of well-balanced positive and negative dc high voltages, and an X-ray generator including such a high-voltage generation circuit. Moreover, when the X-ray generator is of an integrated type, the X-ray generator can be readily made compact.

Many widely different embodiments of the invention may be constructed without departing from the spirit and the scope of the present invention. It should be understood that the present invention is not limited to the specific embodiments described in the specification, except as defined in the appended claims.

### BRIEF DESCRIPTION OF THE DRAWINGS

FIG. 1 picturesquely shows the configuration of an X-ray irradiation/detection apparatus.

FIG. 2 schematically shows the appearance of an X-ray generator.

FIG. 3 is a schematic exploded view of the X-ray generator.

FIG. 4 is a block diagram showing the electric configuration of the X-ray generator.

FIG. 5 is a circuit diagram showing part of the electric configuration of the X-ray generator.

### DETAILED DESCRIPTION OF THE INVENTION

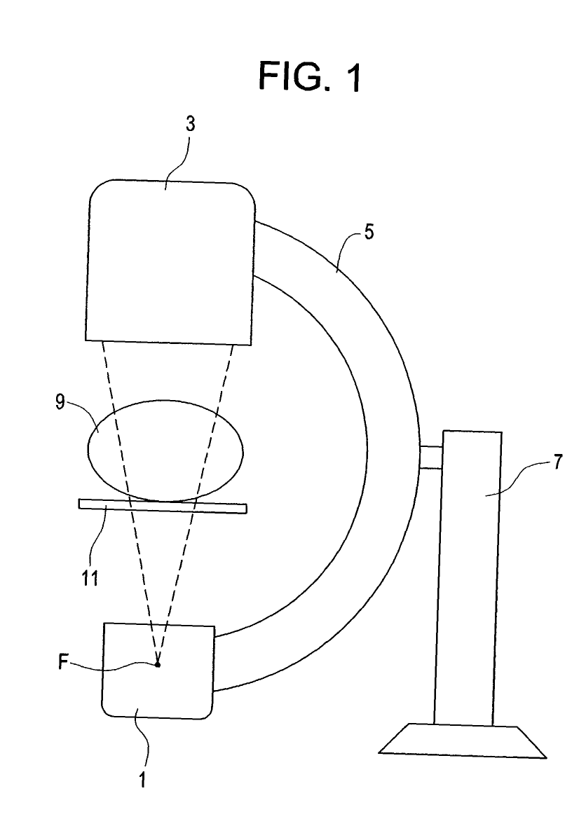

An embodiment of the present invention will be described with reference to drawings below. FIG. 1 picturesquely shows the configuration of an X-ray irradiation/detection apparatus for an X-ray fluoroscopy system. As illustrated, the X-ray irradiation/detection apparatus has an irradiator 1 and a detector 3 supported with both ends of a support arm 5, which is shaped like letter C, and opposed to each other with a space between them. The support arm 5 is borne by a stand 7.

An object of fluoroscopy 9 lying down on a cradle 11 is carried into the space between the irradiator 1 and detector 3. The irradiator 1 has an X-ray tube incorporated therein. As indicated with dashed lines, a conical X-ray beam spread from a focal point F is irradiated to the object 9. X-rays pervious to the object 9 are detected by the detector 3. An X-ray generator to be described below is adopted as the irradiator 1 included in the X-ray irradiation/detection apparatus.

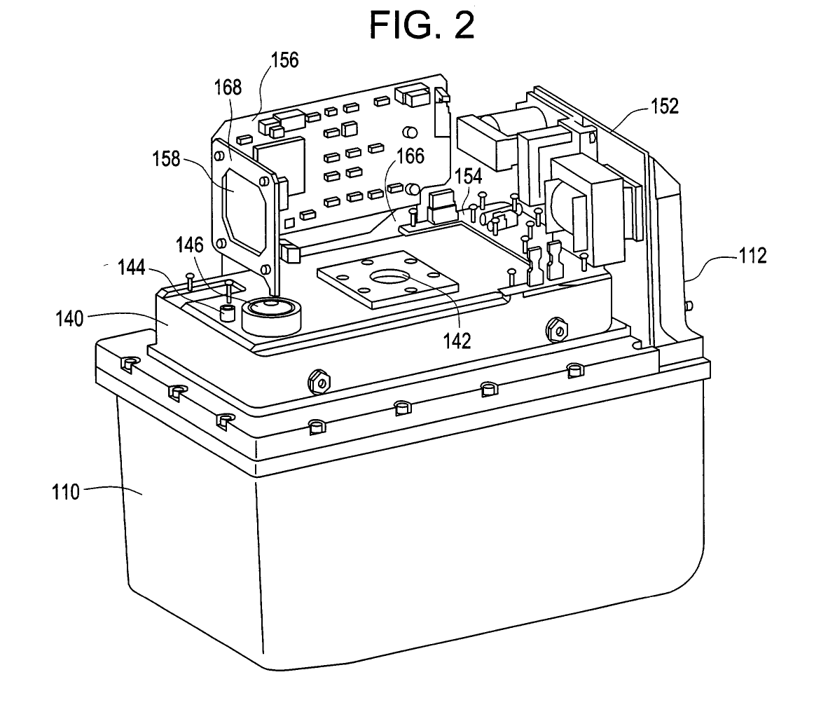

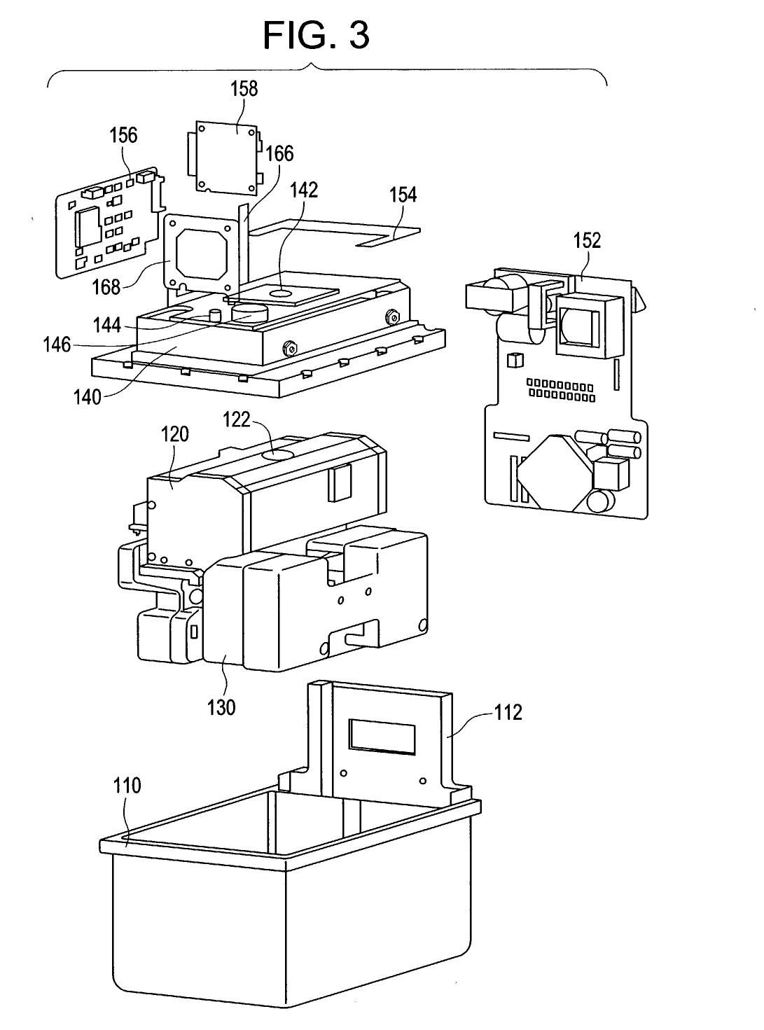

FIG. 2 schematically shows the appearance of an integrated type X-ray generator. The appearance of the X-ray generator is shown with an upper cover removed. FIG. 3 shows the X-ray generator having the components thereof disassembled.

As shown in FIG. 2 and FIG. 3, the X-ray generator includes a case 110 that is a substantially rectangular parallelepiped metallic case whose top is left open. The case is made of a metal, for example, an aluminum (Al) alloy. The case 110 has an extension wall 112 that is an upward extension of one of side walls thereof. The side wall having the extension wall 112 is a two-ply wall.

An X-ray tube container 120 and a high-voltage unit 130 are put in the case 110. The X-ray tube container 120 and high-voltage unit 130 are mounted in such a manner that the X-ray tube container 120 overlooks the high-voltage unit 130. The X-ray tube container 120 has an X-ray tube incorporated therein. The high-voltage unit 130 applies a voltage to the anode and cathode of the X-ray tube incorporated in the X-ray tube container 120. The external surface of the high-voltage unit 130 is coated with an electrically insulating material, whereby the external surface is electrically isolated from the internal surface of the case 110. The high-voltage unit 130 includes a high-voltage generation circuit and a voltage sensor that will be described later. Moreover, the high-voltage unit 130 includes a circuit that feeds a filament current to the X-ray tube.

The X-ray tube container 120 has an opening 122 for X-ray emission formed in the top thereof. The X-ray tube container 20 is made of a material impervious to X-rays and structured to emit X-rays through the opening 122 alone. With the X-ray tube container 120 and high-voltage unit 130 put in the case 110, the opening of the case 110 is sealed with a lid 140. The lid 140 has an X-ray emission window 142 formed at a position coincident with the position of the opening 122 of the X-ray tube container 120. The X-ray emission window 142 is a window sealed with a thin panel pervious to X-rays. The thin panel is made of, for example, aluminum.

The sealed case 110 is filled with an electrically insulating liquid, for example, oil. The poured liquid infiltrates into the X-ray tube container 120 through the opening 122. The liquid is poured through an inlet 144 formed in the lid 140. The inlet has a non-return valve so as to prevent leakage of a poured liquid.

The lid 140 has bellows 146 that absorbs temperature-dependent expansion of an internal liquid. The bellows 146 is realized as a small container whose capacity varies with expansion or contraction of the internal liquid.

A printed-circuit board 152 is attached to the internal surface of the extension wall 112. The printed-circuit board 152 has a lower half thereof inserted into the two-ply wall of the case 110. An inverter circuit that will be described later is formed on the printed-circuit board 152. The inverter and high-voltage unit 130 are connected to each other by way of an electric path (not shown) that penetrates through the lid 140 with the case kept watertight.

Printed-circuit boards 154, 156, and 158 are attached to the lid 140. The printed-circuit board 154 is attached to the top of the lid 140 in such a manner that the surface thereof will lie parallel to the top of the lid around the X-ray emission window 142. The printed-circuit boards 156 and 158 are attached to the flanks of the lid 140 with supports 166 and 168 between them in such a manner that the surfaces thereof lie at right angles to the top of the lid 140. The printed-circuit boards 152 to 158 are located at positions at which X-rays emitted through the X-ray emission window 142 will not fall.

Facilities constituting a control circuit that will be described later are appropriately distributed to the printed-circuit boards 154, 156, and 158. The control circuit and a voltage sensor are connected to each other by way of an electric path (not shown) that penetrates through the lid 140 with the case kept watertight.

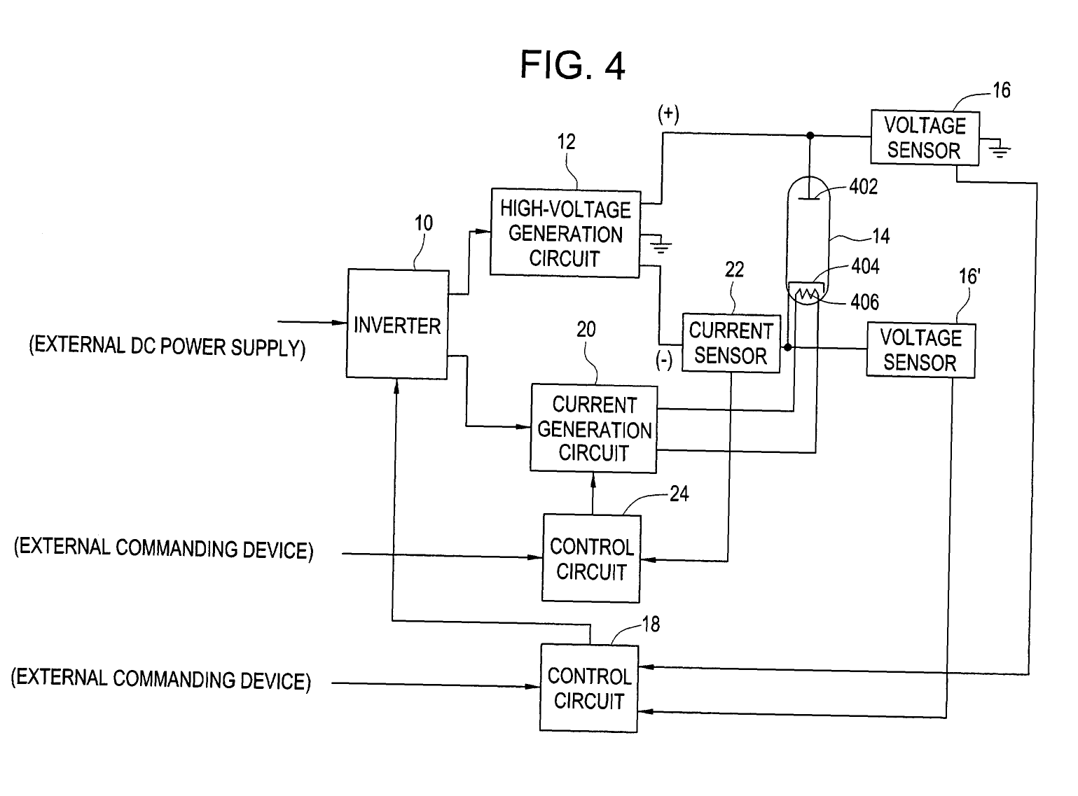

FIG. 4 is a block diagram showing the electric configuration of the X-ray generator. The X-ray generator is an example of the embodiment of the present invention. The configuration of the X-ray generator represents an example of the embodiment of the X-ray generator in which the present invention is implemented.

As illustrated, the X-ray generator includes an inverter 10. The inverter 10 changes a dc voltage delivered from an external dc power supply that is not shown into an ac voltage having a frequency of, for example, several tens of kilohertz, and transfers the ac voltage to a high-voltage generation circuit 12. The high-voltage generation circuit 12 uses a transformer to step up the received ac voltage, rectifies the resultant ac voltage, and generates a pair of positive and negative dc high voltages. The pair of positive and negative dc high voltages are, for example, +60 kV and −60 kV. The positive dc high voltage is applied to the anode 402 of the X-ray tube 14, while the negative dc high voltage is applied to the cathode 404 thereof. Consequently, there is a potential difference of, for example, 120 kV between the anode and cathode.

An anode voltage and a cathode voltage are detected by voltage sensors 16 and 16′, and fed back to a control circuit 18. The control circuit 18 controls the inverter 10 so that the potential difference between the anode and cathode, that is, a tube voltage will be retained at a predetermined value. An external commanding device that is not shown is used to give a control command to the control circuit 18. The control circuit 18 controls the tube voltage in response to the control command.

The inverter 10 transfers an ac voltage to a current generation circuit 20. The current generation circuit 20 changes the ac voltage into a current and feeds the current to the filament 406 of the X-ray tube 14. The filament 406 serves as a heater for heating the cathode 404. The current generation circuit 20 adjusts a filament current to adjust the tube current of the X-ray tube 14. The relationship between the filament current and tube current is predefined and therefore utilized in order to adjust the tube current.

The tube current is detected by a current sensor 22 connected in series with a tube current node at which the tube current of the X-ray tube 14 is observed. The detection signal representing the detected tube current is received by the control circuit 24. The control circuit 24 controls the current generation circuit 20 so that the tube current will be retained at a predetermined value. An external commanding device that is not shown is used to give a control command to the control circuit 24. The control circuit 24 controls the tube current in response to the control command.

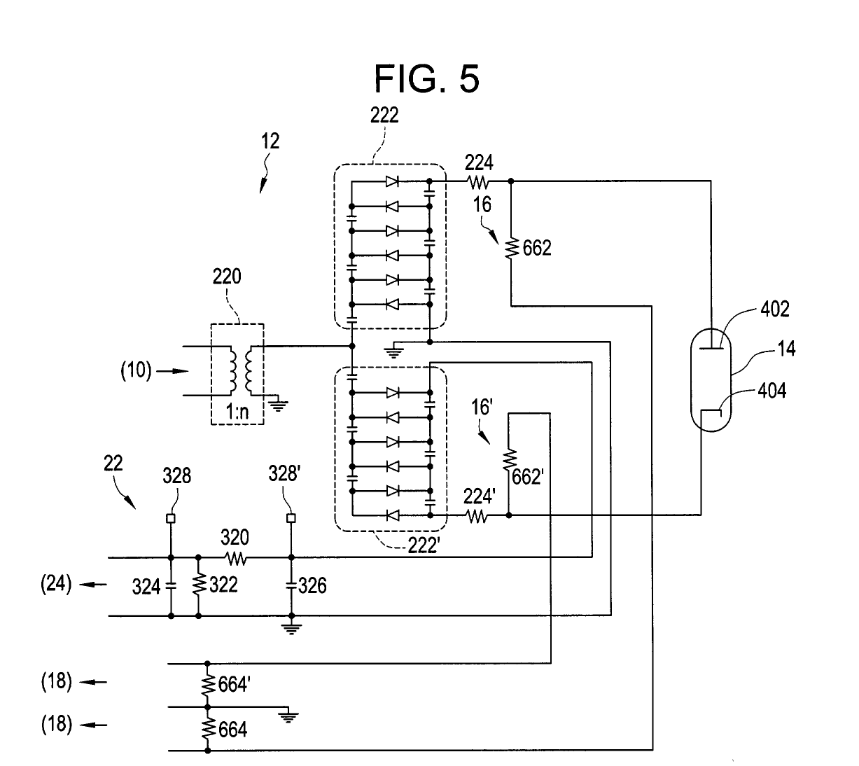

FIG. 5 shows an electric circuit composed of the high-voltage generation circuit 12, X-ray tube 14, voltage sensors 16 and 16′, and current sensor 22. As illustrated, the high-voltage generation circuit 12 includes a transformer 220, step-up circuits 222 and 222′, and resistors 224 and 224′.

The transformer 220 steps up an ac voltage, which is applied to the primary winding thereof by the inverter 10, to produce an output voltage that is n times higher than the input ac voltage, and transfers the output voltage from the secondary winding thereof. Herein, n denotes, for example, 50. One terminal of the secondary winding of the transformer 220 is grounded, and the other terminal thereof is connected to a node between a pair of step-up circuits 222 and 222′ that is connected in parallel with each other. The pair of step-up circuits 222 and 222′ is each realized with a rectifier-type dc high-voltage generation circuit composed of a plurality of stages each including a diode and a capacitor. The rectifier-type dc high-voltage generation circuit may be referred to as a Cockcroft's circuit.

The Cockcroft's circuit performs on multiple stages rectification of an input ac voltage using a diode and charging of a capacitor, and thus steps up the input ac voltage. In this example, the number of stages on which a capacitor is charged is six. Therefore, a dc voltage six times higher than the input voltage is produced. Incidentally, the number of stages is not limited to six but may be set to any value corresponding to a desired multiple that is equivalent to a result voltage produced by stepping up an input voltage.

Between the pair of step-up circuits 222 and 222′, the polarities of dc voltages resulting from rectification achieved by diodes are opposite to each other. Consequently, the pair of step-up circuits 222 and 222′ produces a pair of positive and negative dc high voltages relative to a ground level. The step-up circuit 222 produces a positive dc high voltage, while the step-up circuit 222′ produces a negative dc high voltage.

As mentioned above, the pair of step-up circuits 222 and 222′ connected in parallel to each other and connected to the same secondary winding of the transformer 220 produces a pair of positive and negative dc high voltages. The pair of positive and negative dc high voltages whose absolute values are equal to each other can be produced readily. In other words, a pair of well-balanced positive and negative dc high voltages can be produced readily. Moreover, the transformer 220 need not have, unlike a conventional one, two secondary windings. This results in a transformer of a smaller volume. Eventually, an integrated type X-ray generator can be easily made compact.

The positive dc high voltage produced by the step-up circuit 222 is applied to the anode 402 of the X-ray tube 14 via the series resistors 224. The negative dc high voltage produced by the step-up circuit 222′ is applied to the cathode 404 of the X-ray tube 14 via the series resistors 224′. A series circuit composed of resistors 662 and 664 is connected between the anode 402 and ground. The series circuit realizes the voltage sensor 16. A series circuit composed of resistors 662′ and 664′ is connected between the cathode 404 and ground. The series circuit realizes the voltage sensor 16′.

The resistors 664 and 664′ are mounted on, for example, the printed-circuit board 154 outside the case 110, and connected to the internal circuits of the case 110 over electric paths with the case kept watertight. The potential difference between both the nodes on both sides of the resistor 664 is fed back to the control circuit 18 as an anode voltage detection signal. The potential difference between the nodes on both the sides of the resistor 664′ is fed back to the control circuit 18 as a cathode voltage detection signal.

The step-up circuit 222 has one terminal of the diode, which belongs to the first stage thereof, grounded. The step-up circuit 222′ has one terminal of the diode, which belongs to the first stage thereof, grounded via the series circuit composed of resistors 320 and 322. Consequently, a current corresponding to the tube current of the X-ray tube 14 flows into the series circuit composed of the resistors 320 and 322.

The series circuit composed of the resistors 320 and 322 realizes the current sensor 22. The potential difference between the nodes on both sides of the resistor 322 is fed back to the control circuit 24 as a current detection signal. A capacitor 324 is connected in parallel with the resistor 322, and a capacitor 326 is connected in parallel with the series circuit composed of the resistors 320 and 322. Thus, low-pass filtering of a feedback signal is achieved.

The resistors 320 and 322 and the capacitors 324 and 326 are mounted on, for example, the printed-circuit board 154 outside the case 110, and connected to the internal circuits of the case 110 over electric paths with the case 110 kept watertight.

A pair of terminals 328 and 328′ is led out from the nodes on both sides of the resistor 320. The terminals 328 and 328′ are used to connect an ammeter. When an ammeter is connected using the terminals 328 and 328′, since an internal resistance of the ammeter is much lower than the resistance of the resistor 320, the whole of a current flowing through the resistor 320 flows into the ammeter in practice. Therefore, a tube current can be measured. This obviates the necessity of temporarily disconnecting the tube current circuit so as to connect the ammeter for the purpose of measuring the tube current.

Many widely different embodiments of the invention may be constructed without departing from the spirit and the scope of the present invention. It should be understood that the present invention is not limited to the specific embodiments described in the specification, except as defined in the appended claims.

1. An X-ray generator comprising:
a transformer for transferring an ac voltage, which is applied to the primary winding thereof and stepped up, from the single secondary winding thereof that has one terminal thereof grounded;
a pair of rectifier-type dc high-voltage generation circuits for generating positive and negative dc high voltages according to an ac voltage developed at the other terminal of the secondary winding; and
an X-ray tube having the positive dc high voltage applied to the anode thereof and having the negative dc high voltage applied to the cathode thereof.

2. An X-ray generator comprising:
an inverter for changing a dc voltage into an ac voltage;
a transformer for transferring an ac voltage, which is applied to the primary winding thereof by said inverter and stepped up, from the single secondary winding thereof that has one terminal thereof grounded;
a pair of rectifier-type dc high-voltage generation circuits for generating positive and negative dc high voltages according to an ac voltage developed at the other terminal of the secondary winding;
an X-ray tube having the positive dc high voltage applied to the anode thereof and having the negative dc high voltage applied to the cathode thereof;
a pair of voltage detection circuits for detecting an anode voltage of said X-ray tube and a cathode voltage thereof; and
a control circuit for controlling said inverter according to detection signals produced by said pair of voltage detection circuits.

3. An X-ray generator comprising:
an inverter for changing a dc voltage into an ac voltage;
a transformer for transferring an ac voltage, which is applied to the primary winding thereof by said inverter and stepped up, from the single secondary winding thereof that has one terminal thereof grounded;
a pair of rectifier-type dc high-voltage generation circuits for generating positive and negative dc high voltages according to an ac voltage developed at the other terminal of the secondary winding;
a current generation circuit for generating a current according to an ac voltage received from said inverter;
an X-ray tube having the positive dc high voltage applied to the anode thereof and having the negative dc high voltage applied to the cathode thereof;
a pair of voltage detection circuits for detecting an anode voltage of said X-ray tube and a cathode voltage thereof;
a current detection circuit for detecting a current that flows through said X-ray tube;
a first control circuit for controlling said inverter according to detection signals produced by said pair of voltage detection circuits; and
a second control circuit for controlling said current generation circuit according to a detection signal produced by said current detection circuit.

4. An X-ray generator according to any of claims 1 to 3, wherein said pair of rectifier-type dc high-voltage generation circuits each includes a Cockcroft's circuit.

5. An X-ray generator according to claim 2 or 3, wherein said pair of voltage detection circuits each includes voltage division resistors.

6. An X-ray generator according to claim 3, wherein said current detection circuit includes a current detection resistor.

7. An X-ray generator according to claim 3, wherein said current detection resistor has a capacitor connected in parallel therewith.

8. An X-ray generator according to claim 3, wherein said current detection resistor includes series resistors, on both sides of which nodes to be used to connect an ammeter connection node are formed.
